(19) United States
(12) Patent Application Publication
(10) Pub. No.: US 2013/0042261 A1
(43) Pub. Date: Feb. 14, 2013

(54) ELECTRONIC VIDEO MEDIA E-WALLET APPLICATION

(71) Applicants: Peter A. Tavormina, Hainesport, NJ (US); Morgan S. Allen, Charlotte, NC (US)

(72) Inventors: Peter A. Tavormina, Hainesport, NJ (US); Morgan S. Allen, Charlotte, NC (US)

(73) Assignee: Bank of America, Charlotte, NC (US)

(21) Appl. No.: 13/206,621

(22) Filed: Aug. 10, 2011

(51) Int. Cl. H04N 21/2543; H04N 21/254; G06K 19/073

(52) U.S. Cl. 725/5; 235/492; 725/60

(57) ABSTRACT

Systems and methods for an electronic video media e-wallet application have been provided. An apparatus for providing a viewer of a video with an electronic video wallet may be included within the scope of the invention. The apparatus may include a radio frequency identification device (“RFID”) tag. The RFID tag may be associated with an item in the video. The apparatus may also include a video camera comprising an antenna. The antenna may receive signals from the RFID tag. The signals may include purchasing information associated with the item.

### FIELD OF TECHNOLOGY

Aspects of the present invention relate to the capability of purchasing items displayed in a video feed.

### BACKGROUND

Currently, internet websites offer for sale a large array of products.

Electronic media also includes many forms of entertainment, such as cable television programs, network television programs, streaming video on the internet, etc. Some, if not all, of these electronic media offer products for sale in the form of commercials or other electronic offerings.

However, in many forms of entertainment media, the offers for sale are typically separated from the forms of entertainment—i.e., offers for sale are commercials directed to selling certain products and the forms of entertainment are directed to entertaining viewers.

It would be desirable to combine the offers for sale with the forms of entertainment such that a user viewing one or more of the forms of entertainment could purchase a product.

It would be further desirable to enhance the user experience by allowing a user to purchase a product that was connected in some way—e.g., displayed in connection with—the one or more forms of entertainment.

It would be yet further desirable to provide a platform for a user to select and purchase items that are displayed, but not necessarily offered for sale, on the one or more forms of entertainment.

It would be still further desirable to enhance such a television viewing platform to more readily allow a user to purchase items using the television viewing platform.

### SUMMARY

A method according to the invention may preferably display, on a video display a video stream to the viewer. The method may further include receiving a user selection of a product referenced within the video stream. The method may then displaying details about the product to the viewer, and display on the display a menu bar that includes an online shopping enhancement icon. The method may further include receiving a selection of the icon and, in response to receiving a selection of the icon, displaying an online shopping enhancement dialogue box including a selectable option for displaying user bank account information.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus that may be used in accordance with the principles of the invention.

FIG. 2 shows a television and a character;

FIG. 3 shows the character of FIG. 2 wearing a piece of clothing highlighted by a visual indicator;

FIG. 4 shows the character of FIG. 2 wearing a piece of clothing that is highlighted by a visual indicator, and offered for sale;

FIG. 5 shows the character of FIG. 2 wearing a piece of clothing that is highlighted by a visual indicator, and offered for sale on a separate ticker;

FIG. 6 shows one embodiment of an apparatus according to the invention;

FIG. 7 is an illustrative flow diagram for enrolling in an eWallet program;

FIG. 8 is an illustrative flow diagram that continues from FIG. 7 and illustrates a method for using an eWallet to purchase items on a video feed according to the invention;

FIGS. 9 and 10 is an illustrated flow diagrams that illustrate a process flow for using an eWallet at an online merchant check out associated with a video feed according to the invention; and

FIG. 11 shows an illustrative Graphical User Interface (“GUI”) including information reporting in accordance with the principles of the invention.

### DETAILED DESCRIPTION OF THE DISCLOSURE

Certain embodiments of the invention are directed to viewers of electronic media such as television, video, internet media (including YouTube, Facebook, Twitter, etc.) Some embodiments may identify products that are offered for sale—e.g., in a display that is nested within the video or in a separate, preferably segregated, portion of the video screen. Thus, when a viewer sees a product displayed and/or advertised in a movie, television show or other electronic media, the viewer may execute a purchase in any number of suitable methods, and with any number of suitable systems, as follows.

Certain embodiments of the invention may identify the displayed products that are available for sale. Such identification may be implemented by embedding a response in the display to a mouse pointer “hover” or mouse pointer “click.” Such a response may include displaying a price, make and model and/or other purchase information over the object and/or an interactive dialogue box on the display.

The video stream may preferably include—e.g., be annotated with—metadata. Such metadata may include purchase price, description, make, model, etc. Such information may be inserted by the video provider at, for example, the video production location, at a cable television head-end or at some other suitable location.

Other identification may include marking each item for sale with a pre-determined outline, shadow, halo or other visual indicator of the purchasability of the item. In such an embodiment, a mouse pointer “hover” or mouse pointer “click” may, again, retrieve purchase information regarding the item.

In such embodiments of the invention, the purchase information may allow the user to make the purchase directly. In some embodiments, the user may make the purchase while continuing to view the electronic media.

In some embodiments of the invention, the application may allow a viewer to store a selected product for later review and/or sharing with others. Such sharing may include e-mailing and/or otherwise electronically transmitting information related to the selected product to others.

Certain embodiments of the invention may include a software and/or hardware platform or tool for providing the ability to identify and/or purchase the products for sale. Such a platform may display an on-screen tool either on the viewable display of the video and/or in a pre-determined portion of the display—e.g., a ticker across the bottom, top and/or side of the screen.

Such a tool may include price, coupon, shipment and/or payment information. The payment information may be pre-loaded for a user-selected payment instrument. Such aspects of the tool may relate to the information set forth in co-pending, commonly-assigned U.S. patent application Ser. No. 12/362,565, entitled AN ELECTRONIC WALLET (“eWallet”), filed on Jan. 30, 2009, which is hereby incorporated by reference herein in its entirety.

In some embodiments, the data stored in the tool may include the customer's primary address, billing addresses and debit and credit card numbers. Such information may be automatically populated into the customer's eWallet profile. Customers preferably are also able to modify their eWallet profile by selecting which addresses and payment methods they would like to add to their eWallet simply by selecting a box or other suitable option or field from their respective online eWallet.

In some embodiments, the price, coupon, shipment and/or payment information may pop-up in an interactive dialogue box in response to viewer selection of the product for sale.

An eWallet for use with a tool according to the invention preferably provides a centralized location to store selected personal information. Customers can store account passwords, loyalty card numbers, frequent flier numbers and even coupon promotion codes. This information can be accessible through the eWallet when the customer is shopping in a video stream or other entertainment media.

The eWallet for use with a tool according to the invention may also provide customers with the ability to control and manage their spending online. Such control and management may be manifested by allowing the users to establish criteria for which selected, preferably predetermined, users are allowed to use the eWallet, define categories for eWallet use and define merchants, video streams and/or other electronic media that are acceptable.

In certain embodiments of the invention, spending accounts with limits and expiration dates can be established, according to the invention, by the user, a retailer—e.g., for use with gift cards, a video stream provider or a website administrator.

In some embodiments of the invention, the ability to establish spending controls may also be implemented together with rules for payment method(s). For example, a debit card may be used for purchases less than a first amount, and a credit card may be used for purchases above the first amount, and a rewards card should be used at specific merchants to earn points. Any other suitable spending control algorithm and/or payment method algorithm may be implemented.

Furthermore, systems and methods according to the invention may provide the ability to use spending accounts like a virtual “gift card” by giving another person a unique card number to use in any electronic media for a set amount and duration. The virtual card can be customized by adding graphics and a personalized message.

While shopping in electronic media, the eWallet may automatically appear when a customer is on a page that requires shipping, billing or payment information. Alternatively, the eWallet may appear as a toolbar option.

To access the tool equipped with an eWallet, a customer may need to authenticate his identity using a site key. The eWallet preferably pre-fills shipping and billing information during checkout.

Use of the tool can protect account information by generating a one-time or recurring temporary credit card number to reduce the risk of losses through exposure of account information. The tool can also display customer checking and credit card balances associated with a predetermined financial institution(s). Alternatively, the tool can display only the financial institution accounts selected to be part of the tool.

The tool may also protect account information by maintaining a static shopping number associated with a user account and providing the user with a second, dynamic, number that can be used in conjunction with the static shopping number. Such a dynamic number may be understood to function similarly to a card verification code (“CVC”) that is typically found on credit cards. The difference between the dynamic number according to the invention and the known CVC is that the dynamic number may change over time, after each use, after a plurality of uses, and/or be limited to a specific value, whereas the CVC may remain static for the typical life of the card, typically without value restriction.

In addition, customers may be provided the ability to transfer funds on the spot during the checkout process.

In certain embodiments, offers that have been negotiated by the participating financial institution can be available to customers at checkout. If the customer accepts the offer, the tool may automatically pre-fill a promotional code field in accordance with the negotiated offer.

In alternative embodiments of the invention, the promotional offer may have been downloaded into the eWallet by the financial institution that supports the eWallet. The financial institution may have obtained the promotional offer through a negotiation with the product provider.

Some embodiments of the invention may include promotional offers associated with the media providers. Such offers may be for any product. Such offers are preferably directed toward the viewers. Such offers may also be for other products offered by the media providers—e.g., for pay-per-view programs, cable subscriptions or other similar products.

Another feature of the invention may be an ability of the tool to capture and store receipts. Such a feature may include a computer storage system that stores purchase, or other transaction, receipts in a digital form.

Customers may also have the ability to establish alerts. For example, the customer may be alerted if a limit is reached on a predetermined spending account. Alerts may be provided when over-limit transactions are made, on a predetermined time schedule, when account balance is low or at any other suitable interval.

Certain embodiments may include an overlay that presents the purchase information. The overlay may not be visible to the user unless they point, hover and/or click over a selected activation area. Certain embodiments may also meta tag available products. Such meta tags may provide access to a viewer to direct the viewer to a web site in order to purchase a product.

In embodiments with a touch screen, the hover, click and point functionality may be provided for a viewer such that the viewer can select various functionality using touch.

In some embodiments, the functionality may be replaced by voice recognition functionality. In such embodiments, various voice commands may be used by the viewer of the electronic media such that the user can identify, access information about and/or purchase saleable items. Certain algorithms, similar to those in use for speakerphones, may be implemented such that the voice of the viewer, or other sound from the viewing environment, may reduce the audio track emitted by the electronic media, thereby allowing the device associated with the electronic media to receive and capture the viewer's voice commands.

In addition, certain embodiments of the invention may allow the viewer to override the electronic media such that the viewer can generate a product display overlay relating to the verbally communicated product.

Such systems and methods according to the invention may preferably provide various marketing advantages for the producer of the products available for sale such as, for example, real time product placement.

In certain embodiments of the invention, parental and/or other supervisory controls may be implemented. Such tools may restrict the genre and value of what items may be purchased. Furthermore, such controls may restrict the items at which such times may be purchased and may also restrict which payment instrument may be used.

In some embodiments of the invention, in the event that the viewer selected a product of interest, the tool may superimpose the product on a pre-loaded likeness—e.g., a computer-generated image based on a photograph—of the viewer or a member of the viewer's friends or family, to see how the product may appear on the selected person. Such embodiments may provide the option to view and/or configure the selected person's body measurements.

In some embodiments of the invention, the tool may limit display of the available products to products that satisfy pre-determined criteria. Such criteria may be system-set or user-defined. For example, the tool may provide only “themed” products—i.e., sports equipment, clothing worn by the lead actor, items touched by an actor, items eaten by an actor, etc. Such restrictions on product display may preferably minimize interruption to the viewing experience.

In certain embodiments of the invention, the tool may save product information and then electronically transmit the information to a memory or other storage device, such as a viewer's phone, or to a viewer's wish list. When the viewer has completed viewing the show—the viewer can view all products that were displayed and/or mentioned in the show. In some embodiments, the viewer can even link the product to a video clip in which the product was displayed and/or mentioned. System-set, or user-defined, parameters may limit the size of the video clip.

In some embodiments of the invention, location of storage of purchasing information may be selected by either the buyer, seller and/or media provider, coordinated by all three—buyer, seller and electronic media provider—or determined in some other fashion. The enablement of the tool may also be based on a system located at the buyer, seller and/or electronic media provider or partially at the buyer, partially at the seller and partially at the electronic media provider. So too, the integration of loyalty cards and coupons, the presentation of payment options, the storage of shipping information and other relevant information may be stored at either the buyer or the seller system's or at some

In certain embodiments, the tool may provide functionality that would send directions/coordinates—e.g., for use with a global position system (“GPS”)—of the closest store selling the item to a viewer's selected phone/navigation system.

In some embodiments, the tool may allow a viewer to jump from a electronic video media to a web site selling product. Further, the system may still save and/or store the program that was being viewed so the viewer may return at a later time (after completing the purchase) and continue to view the show from the point of interruption.

In yet other embodiments of the invention, the tool may support a service whereby the viewer has selected a product and initiated a telephone call by the system to a vendor selling the product. Then, the call may be routed to the viewer's home phone to complete the purchase and/or to gather additional information about the product.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

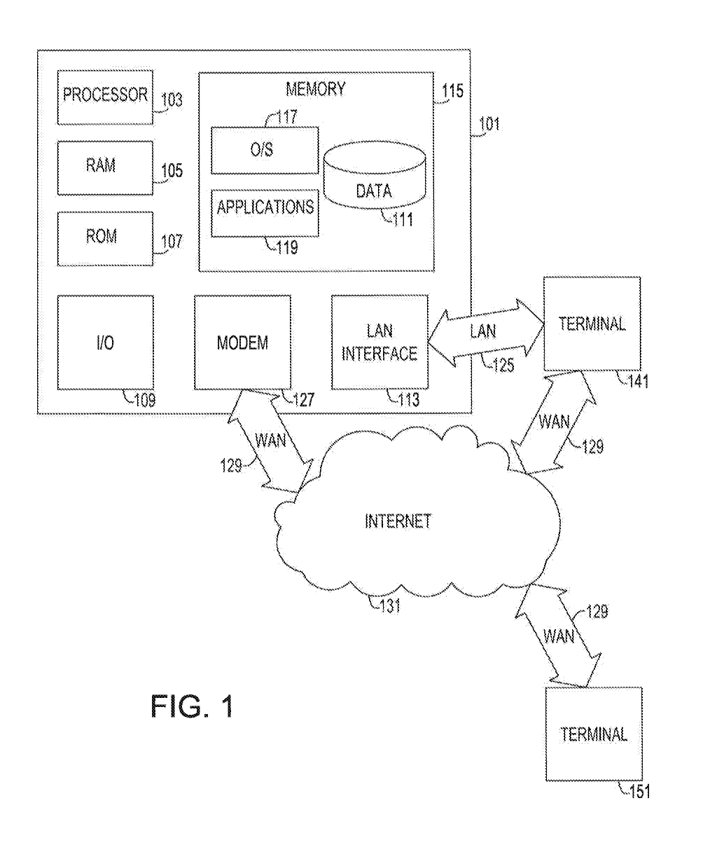

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive reports, transactions, statements, and perform any other suitable tasks related to bank data consolidation and display.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information, transactions, product information, purchase information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: banking data consolidation and display and performing any other suitable tasks related to detection, identification and/or characterization of saleable items, purchasing such items and storing and recalling user identification information.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

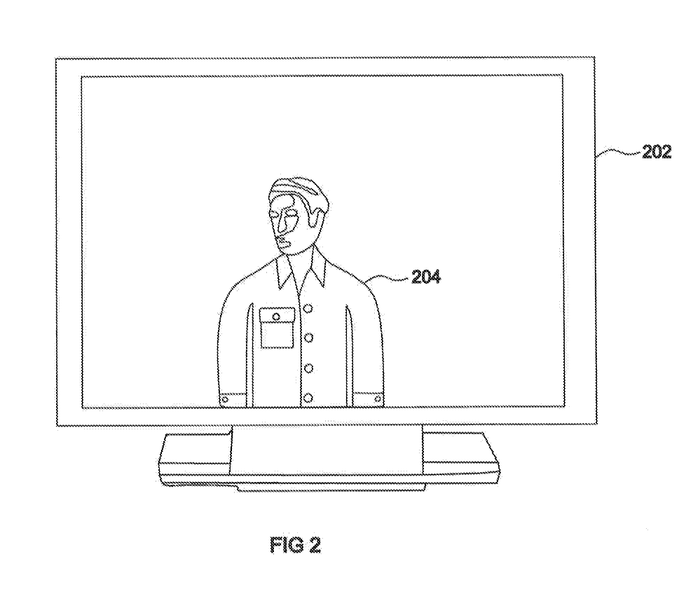

FIG. 2 shows a television 202 and a character 204. The character may be wearing clothing.

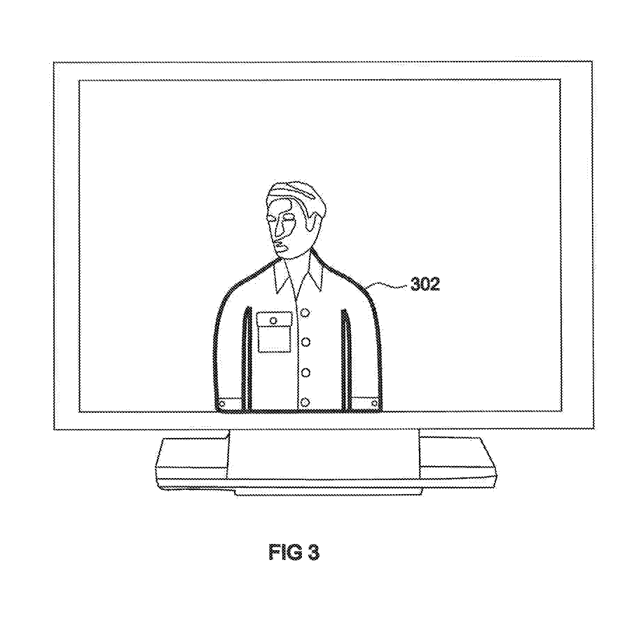

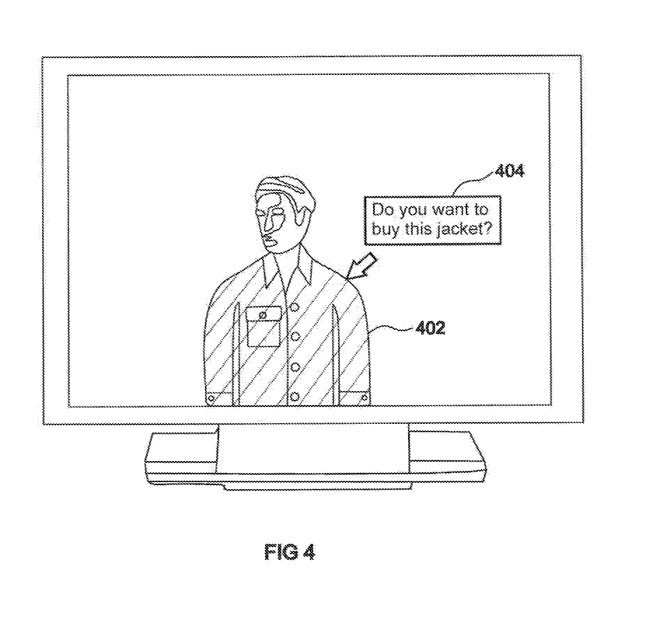

FIG. 3 shows a shirt 302 including a visual indicator. The visual indicator visually distinguishes the shirt from the rest of the video information. Such an indication may communicate to the user that shirt 302 is for sale. Such indication may indicate a “hot spot” superimposed on the video that can be selected/clicked with a pointing device—e.g., a remote control, Wii™ or Xbox™ motion capture device, etc.—for purchase. In the alternative, there may be an overlay (see FIG. 4) on a video feed that can be activated by pointing at a product to see if the product is for sale. The overlay may be invisible prior to being activated.

FIG. 4 shows the shirt 402. Shirt 402 includes hatching. Such hatching may or may not be part of a visual indicator of the fact that the shirt may be purchased.

FIG. 4 also shows a pointer adjacent the shirt together with a text box which states, “Do you want to buy this jacket?” Such a pointer and text box may be responsive to a viewer moving a mouse, a joystick or other input device in order to hover and/or select shirt 402. Shirt 402 may be distinguished using a known automatic object/edge detection algorithm or other suitable algorithm.

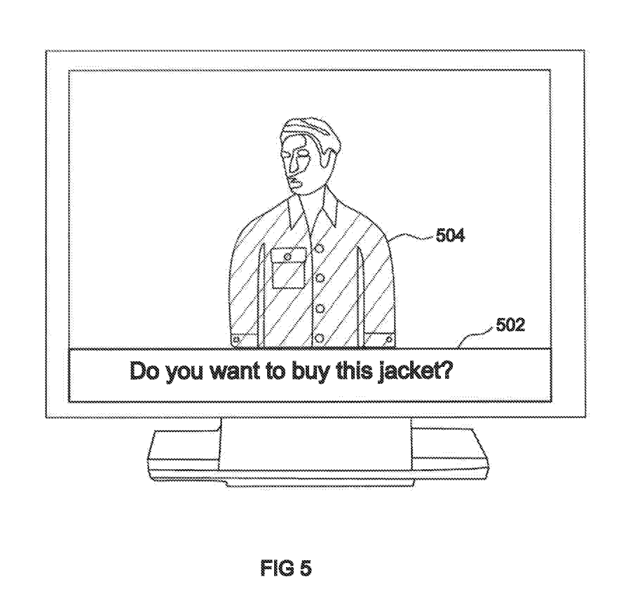

FIG. 5 shows shirt 504 and sidebar 502. Side bar 502 may be responsive to a viewer moving a mouse, a joystick or other input device in order to hover and/or select shirt 504. In alternative embodiments, side bar 502 may appear automatically when an item that may be purchased appears on the screen. Such appearances may preferably be independent of any user identification and/or selection.

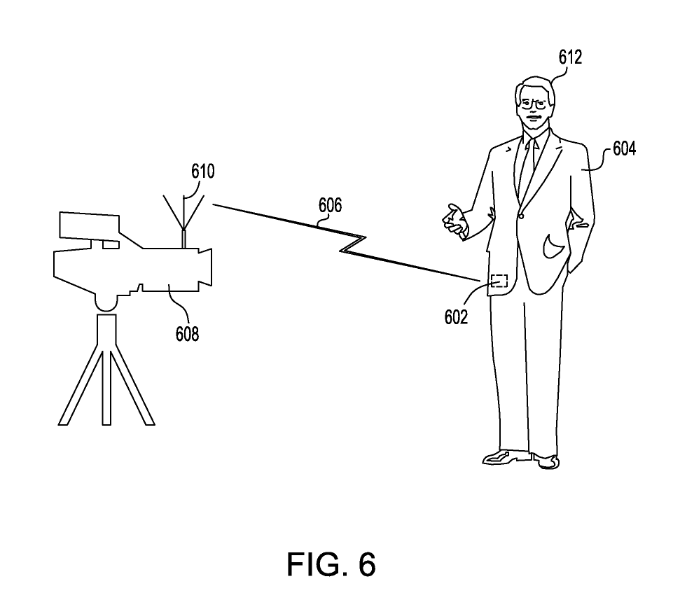

FIG. 6 a system for use with apparatus and methods according to the invention. FIG. 6 shows a jacket 604 of an actor. Jacket 604 may preferably include a Radio Frequency Identification Device (“RFID”) tag 602 that is invisible to the video viewer.

Tag 602 may preferably emit, under certain conditions, a wireless signal 606. Such a signal may include information regarding the jacket. Such information may include the identity of the actor, whether the identity with respect to the video—i.e., the lead actor 612—or the real identity, who is wearing the jacket.

A motion picture camera 608 may include an antenna 610 to receive and store signals from RFID tag 602. Thus, while motion picture camera 608 is filming the video, motion picture camera 608 may also be recording information regarding saleable items that are appearing on the video. It should be noted that the antenna may be remote from the camera. There may also be more than one antenna that are remote from one another. Such multiple antennas may be used to obtain the coordinates of the RFID tag. Then the coordinates may be plotted in the information stored within the video frame. Thereafter, the coordinates may be used to edge detect the object within the frame. The tag will plot inside a border of an object whose edges were detected. Then the edges can be made visible as shown to the viewer. The system may then display purchasing information and the viewer can click to purchase.

Such information may be stored for later use. Such later use may include providing the information regarding saleable items together with the video feed in order to enable a viewer to select and/or purchase certain items. Such information may also further enable genre selection by the system and/or the viewer in order to determine which items will be for sale during a pre-determined video viewing.

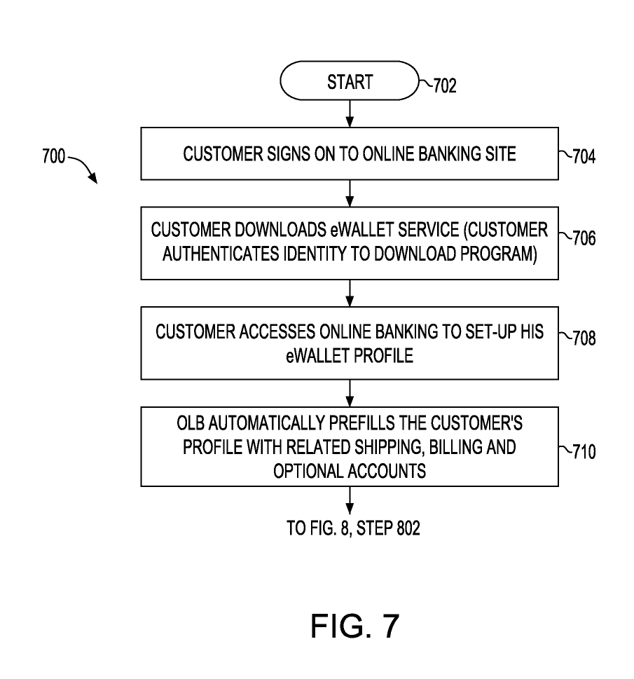

FIG. 7 shows an illustrative flow diagram of a process 700 for setting up an eWallet profile according to the invention. To participate in the eWallet service, customers preferably enroll in online banking (“OLB”) and have a related credit card and/or debit card.

Process 700 may start at 702. The customer accesses the online banking website 704 to download the wallet 706. The customer may be prompted to authenticate his identity prior to downloading the wallet.

Once the wallet is downloaded, customers can access online banking to establish his eWallet profile, 708. At 710, The OLB preferably automatically pre-fills the customer's profile. Online Banking can pull in the relevant shipping, billing and payment information from the system of record(s). The process according to the invention can display the eligible payment accounts and billing address.

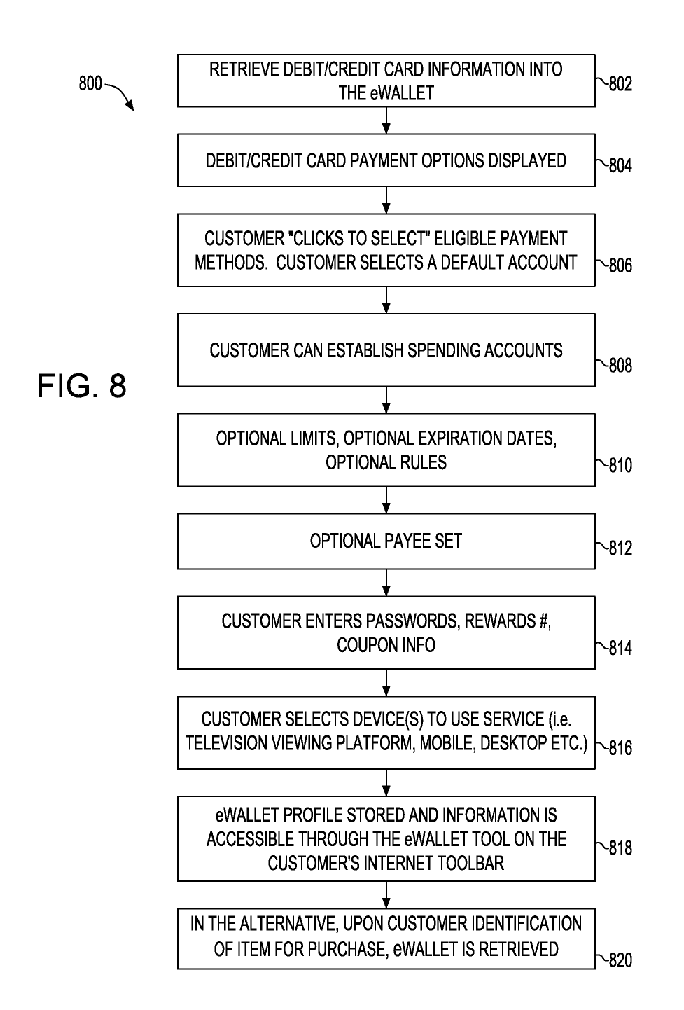

FIG. 8 continues from FIG. 7. Step 802 shows retrieving debit/credit card information into the eWallet. Then, the debit/credit card payment options are displayed, 804. Step 806 shows that customers can “click” the boxes beside the accounts they want to be part of the eWallet and can select a default account for present and future purchases.

The customer can also establish spending accounts, 808. Such spending accounts may also include optional and/or selectable limits, optional and/or selectable expiration dates and optional and/or selectable rules, 810. In certain embodiments of the invention, these accounts may be set according to the payee preferences, 812.

In some embodiments of the invention (not shown), an additional user function may be provided that allows a user to set up a virtual gift card or allowance account.

Further embodiments of the invention allow a user to enter and store security information in computer memory. Such security information may include passwords, frequent flier numbers and loyalty card numbers, 814. Such a storage feature may also allow customers to retrieve and enter coupon codes and/or promotion codes.

A customer may select the device to use the eWallet service, 816. Such a selected device may include a video device such as a television screen, a laptop, a cell phone, Blackberry™, or any other suitable device for storing, transmitting and/or transporting relevant information.

Step 818 shows that the enrollment process may be completed by storing the eWallet Profile and providing access to the information through the eWallet tool on the customer's internet toolbar. In the alternative, step 820 shows that, upon customer identification and/or selection of an item for purchase in a video feed, the eWallet may be retrieved.

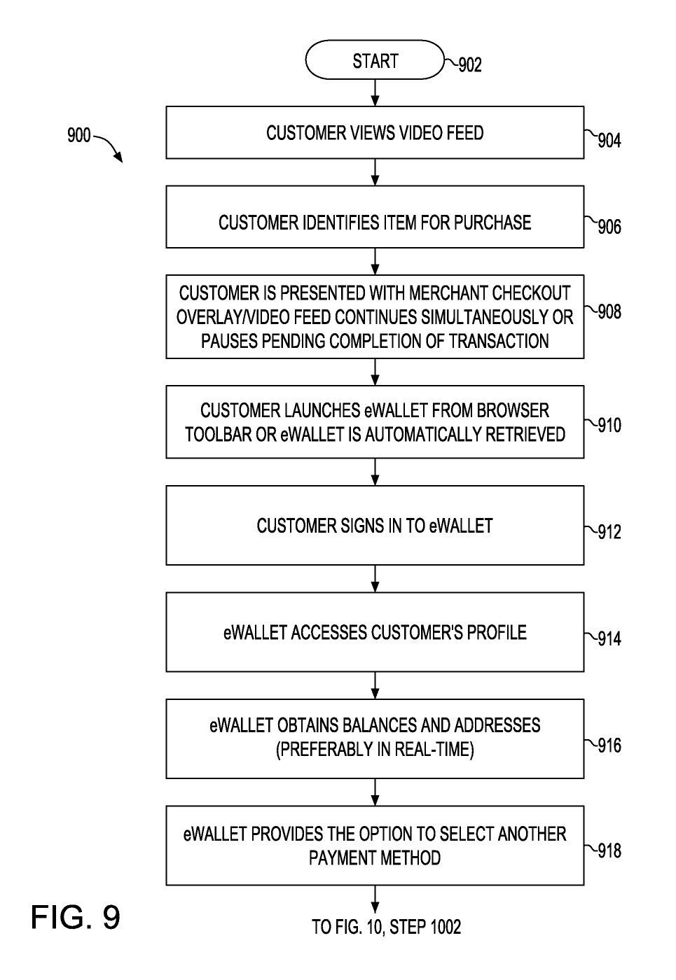

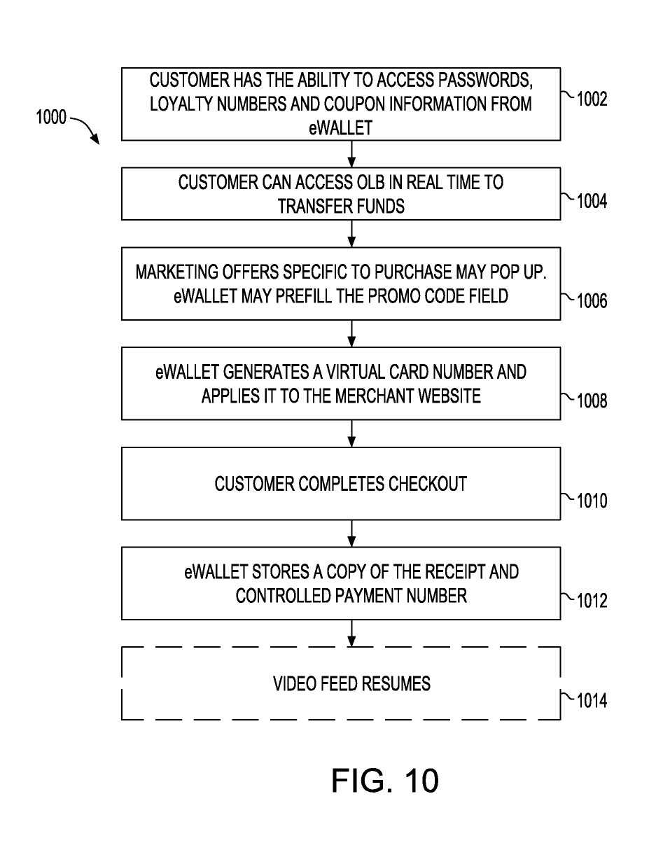

FIGS. 9 and 10 show flow diagrams that illustrate a process flow 900-1000 for using an eWallet at an online merchant check out associated with a video feed. The process starts at 902. Step 904 shows the customer viewing the video feed. Step 906 shows that the customer identifies an item(s) for purchase.

When the customer proceeds to merchant checkout, 908, an overlay appears and the video feed continues simultaneously or, in the alternative, stops, pending completion of the transaction. Step 910 shows that, at merchant checkout, the customer may click on the eWallet icon and launch the eWallet, or, alternatively, the eWallet may be automatically retrieved.

The customer should preferably authenticate his identity—e.g., enter an eWallet access code, or otherwise identify himself in a suitable manner—in order to access eWallet information and features, 912.

In certain embodiments of the invention, a suitable sensor, such as the Kinect® sensor manufactured by Microsoft Corporation of Redmond, Wash., may be used for facial, or other biometric, recognition in order to authenticate the user's identity. Any other biometric authentication, such as fingerprint detection, iris detection, etc., is within the scope of the invention.

Step 914 shows that, preferably in response to customer authentication, the eWallet accesses the customer's profile. At this point, the eWallet preferably displays, in real time, the customer's account balances and the customer's payment options, 916. The eWallet may also provide the option to select another payment method, 918.

FIG. 10 shows an illustrative flow diagram that shows a continuation of the process from FIG. 9. Step 1002 shows using the eWallet to access passwords, loyalty numbers and coupon information from eWallet. When the customer accesses his eWallet, he can select a link to online banking, 1004, and transfer funds in real time to cover purchases.

Another feature of the invention relates to offers negotiated by the financial institution such as a bank. When a customer is searching for a particular item on the internet, the wallet can automatically present offers to them relevant to their search. The bank's negotiated offers relevant to the customers purchase can be presented, 1006. For example, if the customer selects the offer, the eWallet will automatically populate the promo code field, 1006.

Yet another feature of the invention can relate to generation of a unique payment number and apply the payment number to a particular merchant website, 1008. The customer can complete the checkout at step 1010.

Step 1012 shows the eWallet capturing a copy of the customer's receipt. Such capturing may be implemented, for example, by doing a ‘screen scrape’ or other suitable recordation of the receipt. The receipt storage feature preferably captures high level information from the receipt—e.g., purchase amount, retailer, date, one-time use number and applicable primary card number—and can store the receipt information, together with other receipt information, in an orderly fashion. Another feature of the invention (see FIG. 10) may include displaying a grid with a group of collected and aggregated receipt information.

Using processes according to the invention, the online shopping customer experience can be improved by leveraging existing online banking infrastructure and account base to expedite the enrollment process, to provide seamless interaction with core bank accounts, to minimize entry clicks, and to provide high-level security.

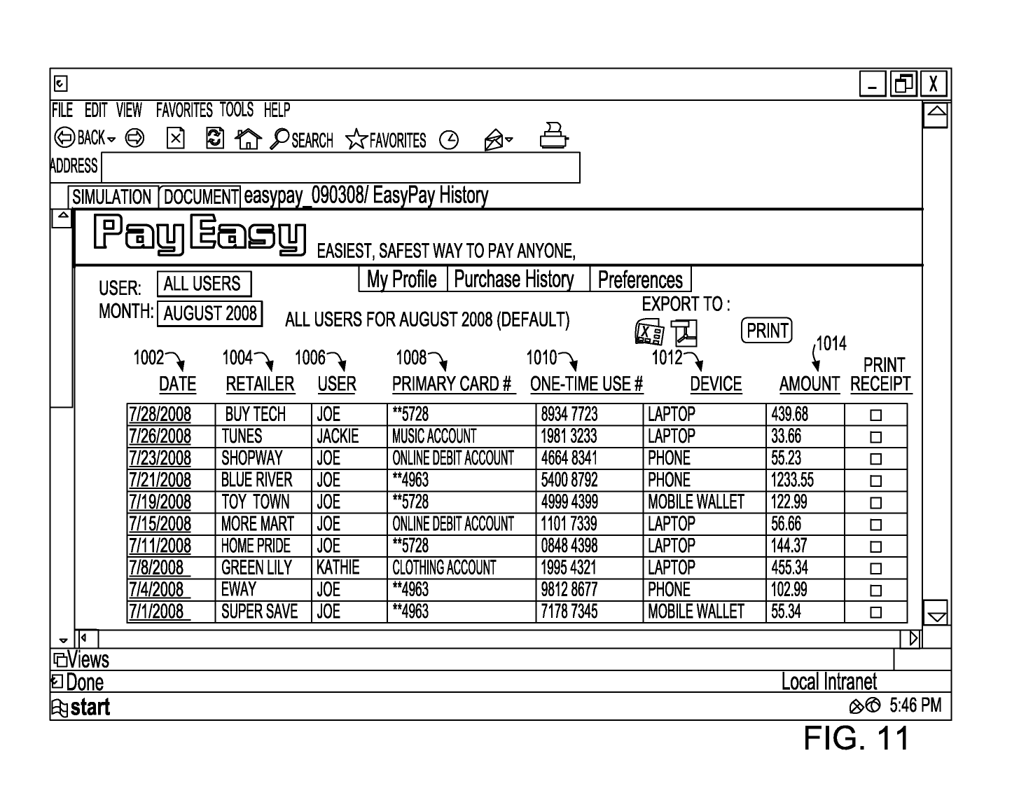

FIG. 11 shows an exemplary screen shot according to the invention. The screen shot shows a Graphical User Interface that may be used to categorize purchase and/or other transactional receipts which can then be viewed and printed at any time.

Such receipts can be sorted by date 1102, retailer 1104, user 1106, primary card number 1108, one-time user number 1110, device number 1112, and/or amount 1114 or any other suitable field. Additionally, the information stored in the screen may preferably be exported into a suitable electronic spread sheet application that are available under the Trademark Excel™, from the Microsoft Corporation, Redmond, Wash.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Thus, methods and apparatus for an electronic video media e-wallet application have been provided. Persons skilled in the art will appreciate that the present invention can be practiced by other than the described embodiments, which are presented for purposes of illustration rather than of limitation, and that the present invention is limited only by the claims that follow.

What is claimed is:

1. One or more non-transitory computer-readable media storing computer-executable instructions which, when executed by a processor on a computer system, perform a method for providing a viewer with a electronic video feed wallet, the method comprising:
displaying on a video display a video stream to the viewer;
receiving a user selection of a product referenced within the video stream;
displaying details about the product to the viewer;
displaying on the display a menu bar that includes an online shopping enhancement icon;
receiving a selection of the icon; and
in response to receiving a selection of the icon, displaying an online shopping enhancement dialogue box including a selectable option for displaying user bank account information.

2. The method of claim 1 further comprising displaying an online shopping enhancement dialogue box including a selectable option for transferring funds between two bank accounts.

3. The method of claim 1 further comprising using electronic information from a bank account associated with the viewer to populate an online shopping profile.

4. The method of claim 1 further comprising using electronic information from a bank account to populate an online merchant checkout dialogue box.

5. The method of claim 1 further comprising using electronic information from a bank account to update an online shopping profile.

6. The method of claim 1 further comprising displaying an online shopping enhancement dialogue box that accesses and displays account balances in real time.

7. The method of claim 1 further comprising displaying an online shopping enhancement dialogue box that accesses and displays special offers relating to a user product keyword search and/or user product purchase.

8. The method of claim 1 further comprising displaying an online shopping enhancement dialogue box that displays an option to transfer funds between the financial institution accounts.

9. The method of claim 1 further comprising:
generating a static shopping number; and
generating a dynamic shopping number;
wherein the static shopping number and the dynamic shopping number may be used together to provide a limited shopping credit line.

10. An apparatus for providing a viewer of a video with an electronic video wallet, the apparatus comprising:
a radio frequency identification device (“RFID”) tag, the RFID tag for association with an item in the video; and
a video camera comprising an antenna for receiving signals from the RFID tag, the signals comprising purchasing information associated with the item.

11. One or more non-transitory computer-readable media for use with the apparatus in claim 10, said media for storing computer-executable instructions which, when executed by a processor on a computer system, perform a method for providing a viewer with the electronic video wallet, the media further configured to:
display on a video display a video stream to the viewer;
receive a user selection of a product referenced within the video stream;
receive the purchasing information from the video camera;
display at least a portion of the purchasing information to the viewer;
display an online shopping enhancement dialogue box including a selectable option for displaying user bank account information.

12. The method of claim 11 further comprising displaying an online shopping enhancement dialogue box including a selectable option for transferring funds between two bank accounts.

13. The method of claim 11 further comprising using electronic information from a bank account associated with the viewer to populate an online shopping profile.

14. The method of claim 11 further comprising using electronic information from a bank account to populate an online merchant checkout dialogue box.

15. The method of claim 11 further comprising using electronic information from a bank account to update an online shopping profile.

16. The method of claim 11 further comprising displaying an online shopping enhancement dialogue box that accesses and displays account balances in real time.

17. The method of claim 11 further comprising displaying an online shopping enhancement dialogue box that accesses and displays special offers relating to a user product keyword search and/or user product purchase.

18. The method of claim 11 further comprising displaying an online shopping enhancement dialogue box that displays an option to transfer funds between the financial institution accounts.

19. The method of claim 11 further comprising:
generating a static shopping number; and
generating a dynamic shopping number;
wherein the static shopping number and the dynamic shopping number may be used together to provide a limited shopping credit line.

20. An apparatus for providing a viewer of a video with an electronic video wallet, the apparatus comprising:
a radio frequency identification device (“RFID”) tag, the RFID tag for association with an item in the video; and
an antenna for receiving signals from the RFID tag, the signals comprising purchasing information associated with the item.
